(19) United States
(12) Patent Application Publication
(10) Pub. No.: US 2014/0173987 A1
(43) Pub. Date: Jun. 26, 2014

(54) Classic Step Store Gate

(71) Applicant: Robert Lee Swafford, West Frankfort, IL (US)

(72) Inventor: Robert Lee Swafford, West Frankfort, IL (US)

(73) Assignee: Robert Lee Swafford, West Frankfort, IL (US)

(21) Appl. No.: 13/915,536

(22) Filed: Jun. 11, 2013

Related U.S. Application Data
(60) Provisional application No. 61/689,658, filed on Jun. 11, 2012.

(51) Int. Cl. E06B 11/02; E05D 7/00

(52) U.S. Cl. CPC E06B 11/022; E06B 11/02; E05D 7/00
USPC 49/247; 16/382

(57) ABSTRACT

I designed the “Classic Step Store Gate”, It does not use a pivot post. Classic, Step Store Gate uses my special hinge made by modifying a strap hinge. “Classic” is different in design; “Classic” has a rounded firm handrail across the top, and can help prevent a fall at the steps. It is used at steps going up or down. The opening end of the gate is lifted to open toward steps or into the room.

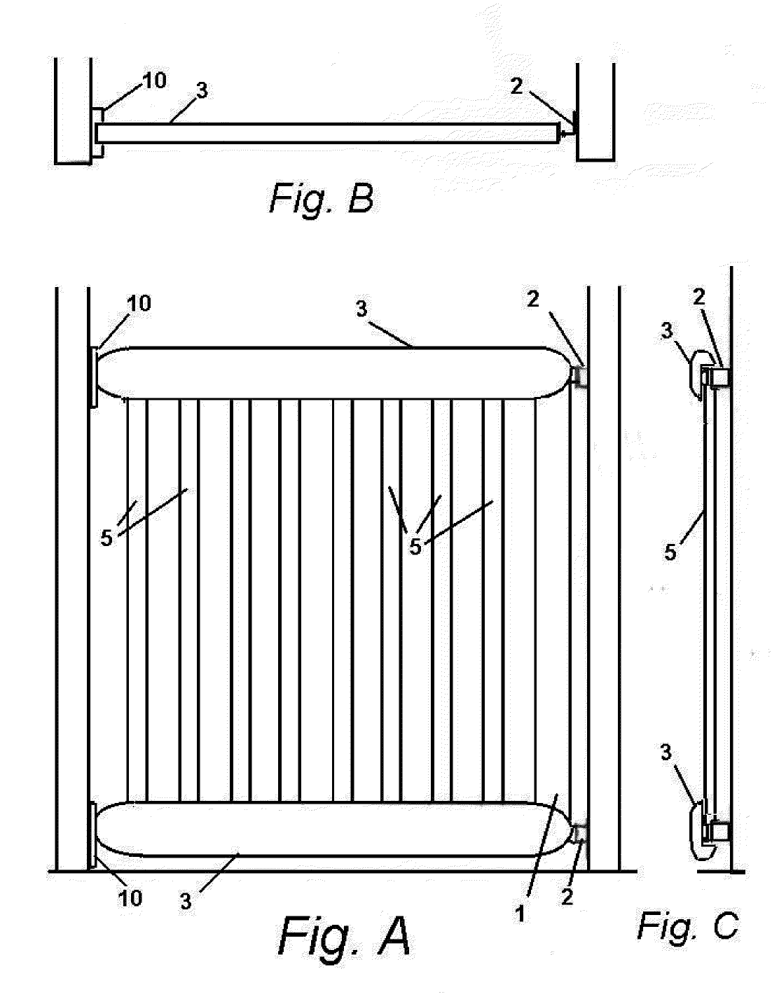

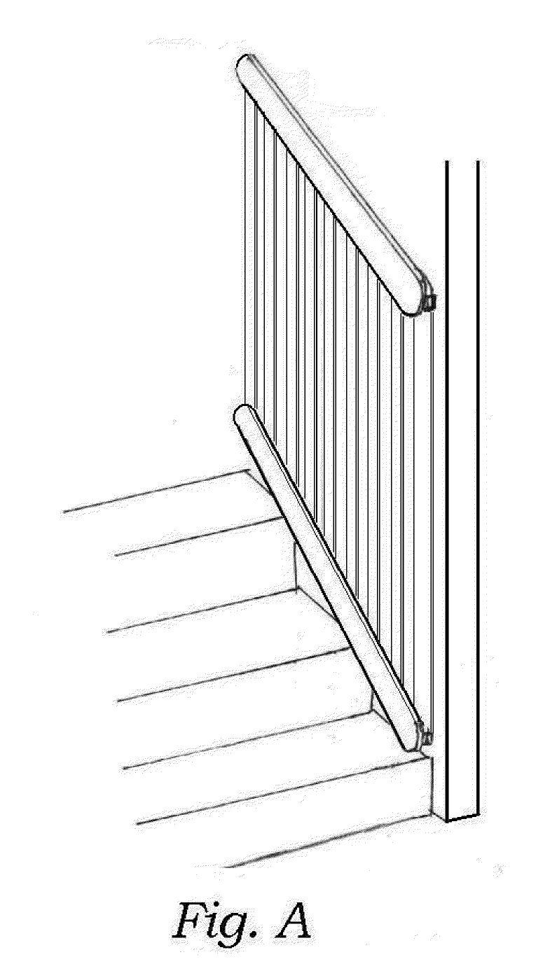

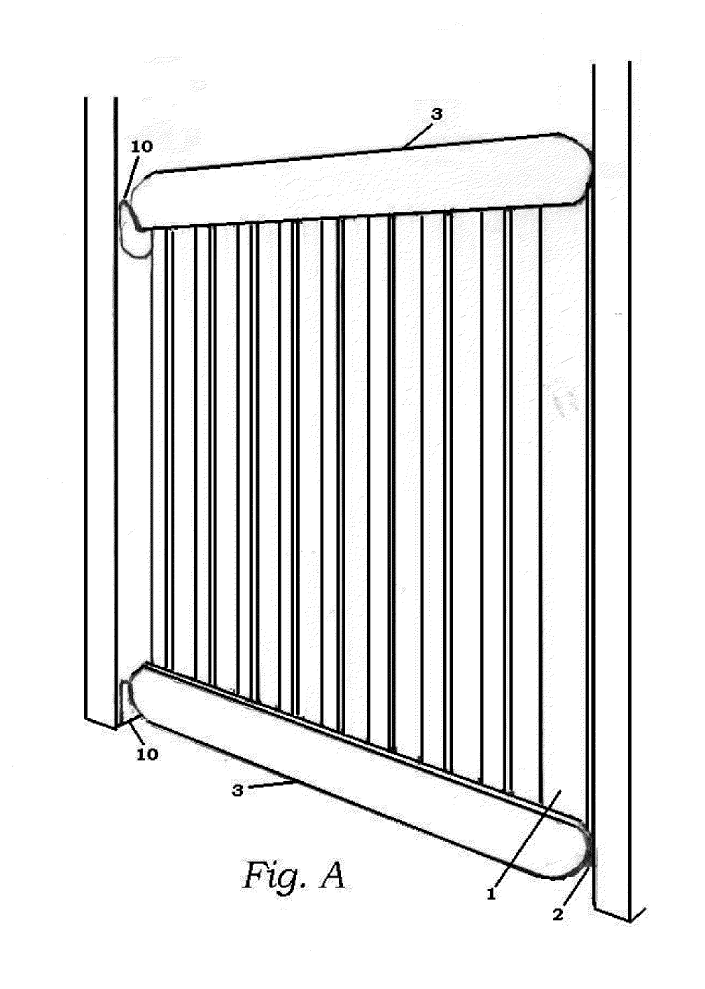

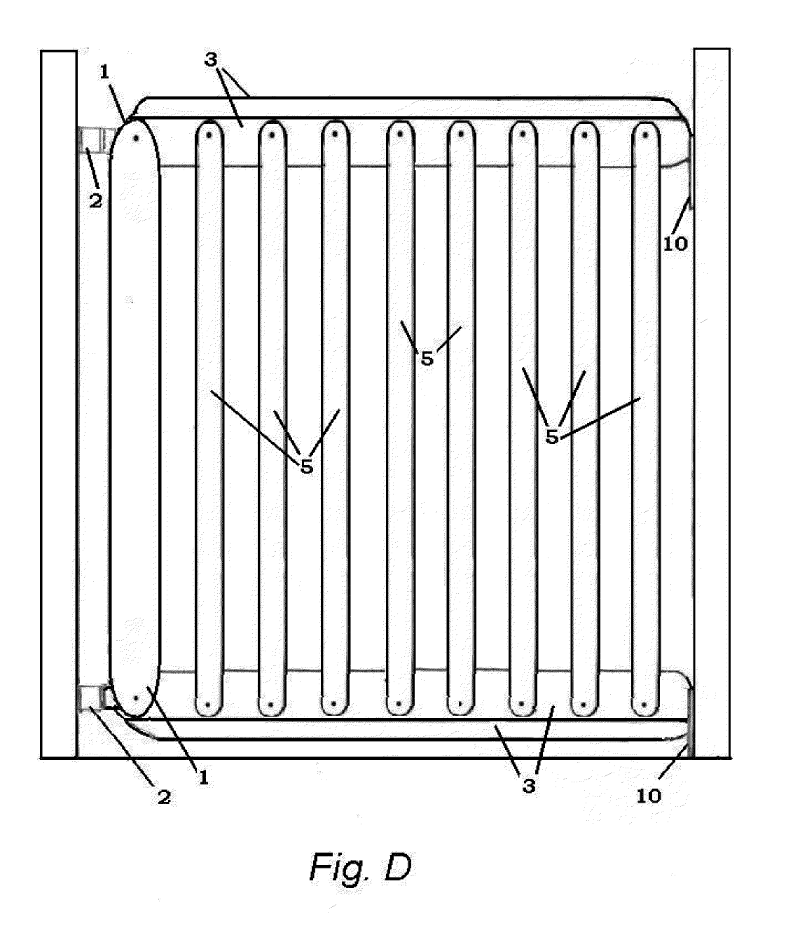

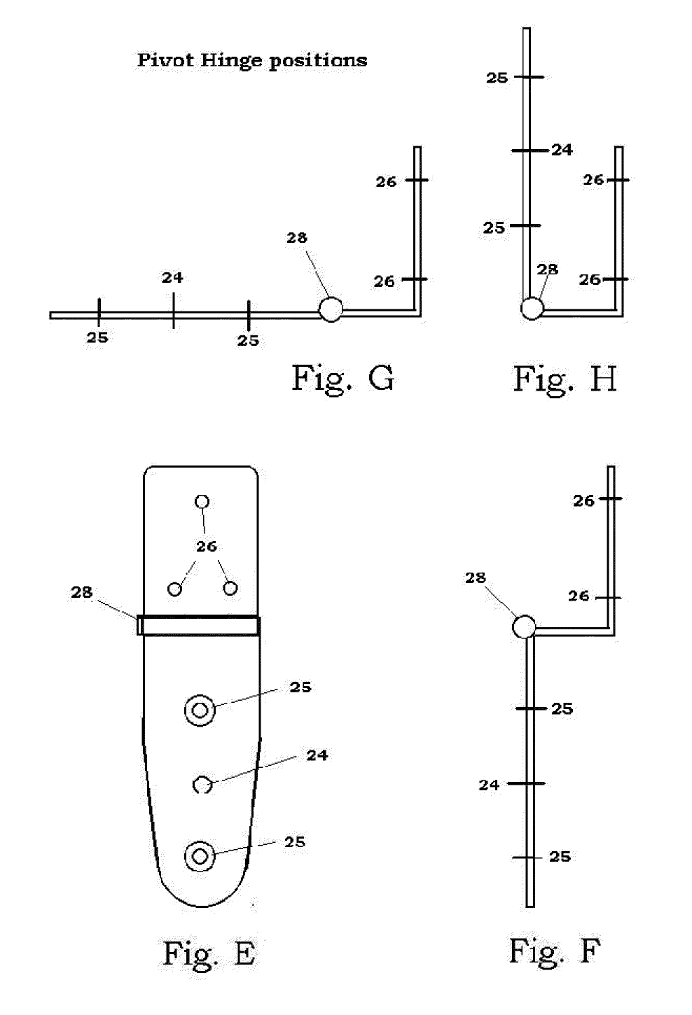

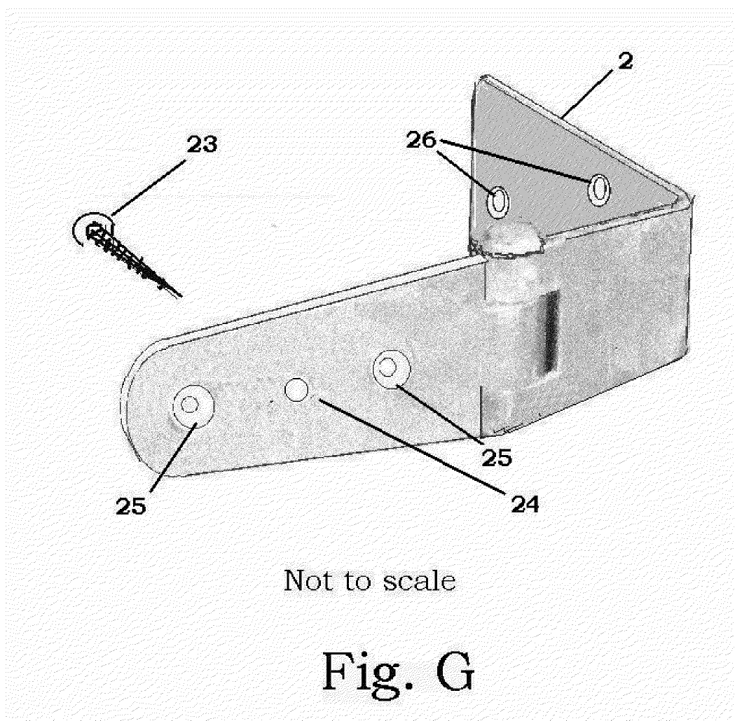

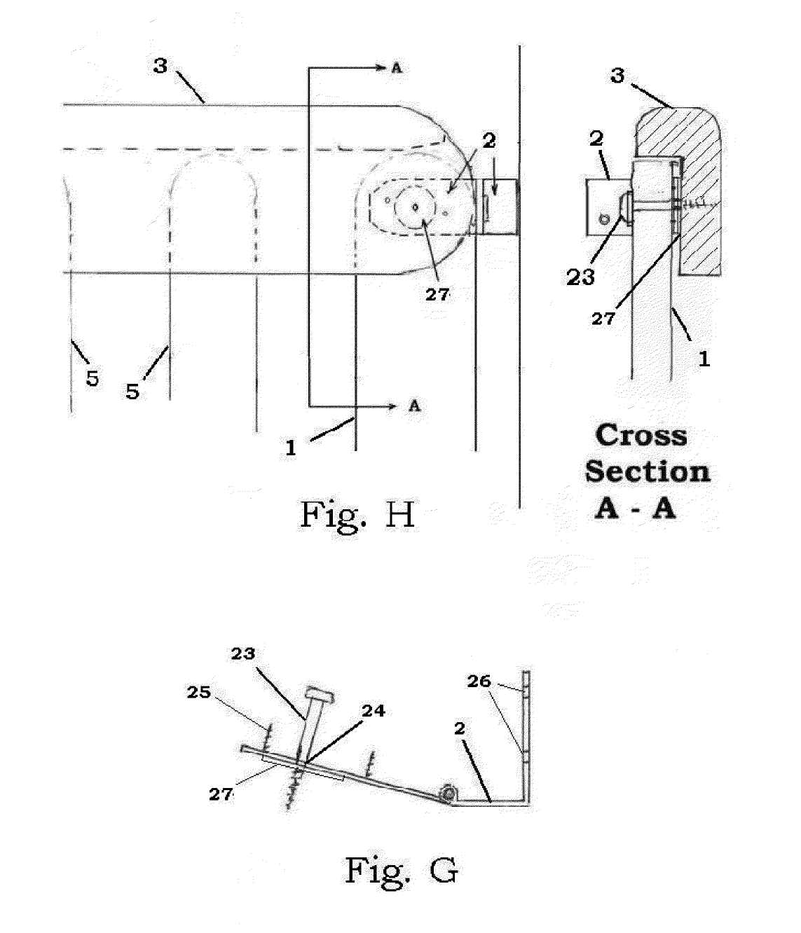

The “Classic Step Store Gate”, has an attractive clean look from the front view, and an interesting mechanical view from the back.
The gate can be stored along the wall on the steps.
When closed the gate rest in “V” tapered brackets to support the end of the gate

Description of gate: Reference to drawings. Classic Step Store Gate, total of seven drawings.

Drawing # 1: Front Elevation Fig. “A”; exhibits a very clean and attractive structure, with no screws, nails or pivot pins visible. Fig. B; Top view, line #3: The horizontal beams of the Classic gate, line #3, is a wide rounded edge handrail measuring, one and one half inches or more in thickness, full width of gate and rounded at the ends. Special hinge line #2 at the right end; gate rest, line #10, on the left: Fig A, Line #1; vertical beam to which special hinges Line #2 are attached. When the gate is closed; the horizontal beams, line #3, rest in tapered notches, Line #10. Fig. C, Shows end view of handrails line #3: The gate lifts or lowers to move up or down stairs or a slope, to open or to block a passageway. It was developed for strength and safety, and is up to date with attractiveness' of quality homes.

Drawing # 2: Rear Elevation exhibits a very un-usual and interesting structure.

Drawing #2, Fig. D; back side of gate, line #5; illustrates lighter weight, smaller width vertical picket; of equal length attached to horizontal beams, line #3. All vertical members pivot points are on a straight line typically one inch from the thick section of the horizontal beams, line #3: Vertical member radius cuts are slightly less measure for operating clearance. Vertical beam, line #1, has the same radius for 90 degrees across the center, falling into a larger radius, 45 degrees each side of center.

The first vertical “picket” is attached near the lifting end of the gate; on the horizontal beam, line #3, with a single pivot screw at each end. Additional vertical members, line #5; referred to as pickets, are spaced equally across the gate.

All vertical members have plastic or nylon washer spacers to insure smooth operation when lifting or lowering the gate. All screws enter from the back side of the gate, and are of correct length not to break through the front surface of the classic step store gate.

Drawing # 3: Fig “A”, Front Elevation perspective, exhibits a very clean and attractive structure with operating end of gate resting in line 10, saddle brackets. These saddles can be of various shapes or sizes and should include a spacer block of equal shape. Spacer blocks can be used to adjust clearance, and stop the gate end from scuffing the wall. Spacer blocks can also be used at hinge end of gate if needed.

Drawing # 4: Fig. “A”, is a perspective view of Classic step store gate in open position, resting on the steps. A rest bracket could be mounted, on the wall near the top, to make a ridged hand hold.

Drawing # 5: Drawings of pivot hinge: Fig. E is the plan view of the “Pivot Hinge”.

Fig F, G, H: Exhibits drawings of top view looking down, on pivot hinge; line #24 is pivot pin hole. Line #25 is holes for flat head screws to attach hinge to vertical beam, line #1. Line #28 is the standard strap hinge pin: Line #26 is used to mount the gate to a door jamb, or a wall. The same numbers represent the same holes in the plan view of the pivot hinge, one of my claims in designing the Classic step store gate.

The three major positions of the gate are. Fig. F, gate opened toward the operator in front of the gate. Fig. G; is the hinge position when gate is closed and resting in saddle brackets. Top view Fig. H; illustrates the gate moved away from the operator to the step store position:

Screws #25; enter at the #25 and hold the vertical beam solid and allow it to rotate horizontally over 180 degrees. Vertical rotation results from this same hinge or “Pivot Hinge”

### Drawing # 5 Continued

The Pivot screw passes through a drilled hole in the vertical beam, then, line #24, in the hinge forming a pivot point, then a nylon washer, and last anchors into the horizontal beam. Through the action of the pivot hinge, the gate is lifted going up stairs, or lowered down a set of stairs and rotated horizontally an vertically, as needed. When the gate is closed, the top rail makes a good safety feature at the top of a stairway or slope. The hinge used with the gate, distributes any stress that might occur, to the steel pivot hinge, line #2.

Drawing #6; Fig. G: Perspective view of hinge:

This gate uses a different method of construction, to allow the loose end of the gate to move upward or downward. I call it a “pivot hinge”:

This gate uses specially modified strap hinges, or specially designed “pivot hinges” line #2; see drawing 6 Fig. G, line 2. One “pivot hinge” is near the top and aligns with pivot screws for vertical beam and pickets, and one near the bottom. These two “pivot hinges” attach to the first vertical member of the gate, line 1, with two flat head screws through holes, line #25, into the vertical beam. Three screw holes, line #26 are for attaching the hinge to the wall or door jamb.

The modified hinges or “pivot hinges” are attached to the vertical beam, screws through two holes, line #25; allowing it to rotate over 180 degrees horizontal; that is directly away from the operator; across the passage way; or move toward the operator standing in front of the gate.

Between the two screws holding the hinge to the vertical beam; the hinge has a pre drilled hole, line #24; for a pivot pin or screw line #23. The hole is slightly larger than the pivot screw. Placing the drill bit in the hinge hole, line #24, a hole is drilled through the vertical beam, equal in size, to the hole in the hinge.

### Drawing #6 Continued

A screw or pivot pin, line #23, made for anchoring into wood, will pass through this prepared hole, entering the back side of the vertical beam, through the attached “pivot hinge”, then through a plastic washer and finally, screw into the top horizontal beam.

This provides for the horizontal beam to pivot up or down vertically; to lift rotate and swing the gate open and store along a wall beside the steps.

A second hinge is used at the bottom of the gate; in conjunction with the horizontal beam and vertical beam. The lower beam is inverted from the position of the top horizontal beam. The lower hinge is installed the same as the top hinge, as described above, using a pivot pin or screw, as used on the first horizontal beam. The gate can be inverted to use as a right or left hinge gate. _o Drawing # 6: Fig. G; Perspective view of hinge: Line #2: Additional details:

This drawing is much easier to understand than mechanical drawings of this simple pivot hinge.

A bent hinge is a common device. The “pivot hinge” is specially designed for this type of gate. Line #2 is the entire hinge, however line #2 is pointing to the wall or jamb mount section. The jamb mount section, line #2; should be 1.75 inches long with rounded corners and 3 mounting screw holes, Line #26. Two holes should be near the bend in the bent section. The bend in the wall or jamb section, should be one inch from the hinge pin, with no holes in the projecting section.

Drawing # 6: Fig. G; Continuing: “pivot hinge”, gate side of hinge; with, line #24, pointing to the pivot hole; with line #25, indicating tapered holes for flat head screws:

The gate section of the hinge, measures approximately two and five eights inches long, with a ½ inch radius rounded end, centered on line #25. The three holes measure ¾ inch centers to center of pivot hole, line #24 and again ¾ inch centers to the second tapered hole, line 25 for two mounting holes to vertical beam, leaving 5/8 inch to the edge of hinge pin cut.

Drawing #7, Fig. H: Front Elevation detail: Exhibits in dotted lines, the rear of the structure, position of hinge, and how the top beam line #3, trims out near the ends. It also shows line #5, pickets, and line #1 vertical beam.

Cross Section A-A shows a one piece horizontal beam, rounded top and some operating clearance, needed when the gate is lifted or lowered to the maximum. The hinge fits between the gate members, and is illustrated as a hinge made for this purpose.

Section A-A also illustrates the gate in the closed position with the top beam section, line #3. The square end of the hinge is fastened to a door jamb, as in my home for which it was designed, or to a wall at the top of declining steps. These gates are very useful and provide safety.

Drawing 7; Fig G shows looking down on pivot hinge, line #2; with gate moved slightly away from the operator. Pivot screw #23 passes through the vertical beam, then through the pivot hole, line #24, in hinge, line #2, and washer, line #27, after it passes through vertical beam, cross section A-A, line #1.

Flat head screws pass through line #25 hole; fastens hinge to vertical beam line #1, before drilling holes for pivot pin through the vertical beam. Holes #26 are provided for mounting to door jamb or wall.

This gate can also be installed with stick on pads which can be removed without damage.

The pads are a standard Item for use in closets or on walls for hanging things.

This gate has no force hanging down, or pulling away from a wall or door frame. It would take a lot of pressure or force, to move these gates out of place, or pull them loose.

1-12. (canceled)

13. Hand hold horizontal beams, are designed and built with a recess for mounting vertical beams flush on the back side; drawing #1, Fig. C; pointer #3, show a recessed area for #5, rounded top & bottom vertical members to be flush on the back side of the gate. Either beam can be used as a top hand rail as they are the same. Vertical pickets rotate in the recessed area as the gate is lifted. Also see drawing # 2; horizontal hand hold beam #3, and vertical pickets #5. Also see drawing #7; Fig. H, cross section A-A Vertical beam #1 and hand hold top beam #3

14. All Vertical beams rounded both ends: this provides equal clearance, as the gate is lifted or lowered. The center of pivot point, are the center of radius, therefore end clearances remain equal as gate is lifted or lowered. Screws or pivot pins are installed from the back of the gate through a drilled hole in the vertical beams or pickets: see drawing #1, Fig “A” front view; drawing #2, Fig. D back view; drawing #3 Fig. “A” Side angle view; drawing #4, Fig. “A” perspective.

15. Specially designed gate hinge:
Drawing #6, Fig G; describes the design of the hinge.
A strap design hinge #2, drawing #6 and #7; is bent 90 degrees, one inch from hinge pin. Pointer # 24 hole is drilled slightly larger than the pivot screw # 23. Pivot screw passes through a slightly larger hole drilled through the vertical beam # 1, and then passes through the hinge and a nylon washer and anchors into the horizontal gate handrail pointer #3. The hinge is first secured to the vertical beam #1 with flat head screws through holes #25. Allowing the pivot point pin to pass through the hinge to strengthen the framework, and places the load of the horizontal beams on the steel hinge, causing it to be a solid structural member. Also see drawing # 5; Fig. E, F, and G. Holes through #2 hinge, #26; are later used to mount the hinge and gate to a door frame or wall.
Drawing #7; Fig. G, gives detail of hinge #2 and pivot pin screw # 23, and nylon washer # 24. Fig H, #2 indicates hinge location and nylon washer, Cross section A-A shows pivot screw 23 passing through vertical member #1, nylon washer between hinge and horizontal beam. Use of the hinge is indicated on drawings as pointer #2: Drawing numbers 1, 2, 4, 5, 6 and 7.
